(19) United States
(12) Patent Application Publication
(10) Pub. No.: US 2010/0135031 A1
(43) Pub. Date: Jun. 3, 2010

(54) Heat-dissipating module and heat-dissipating apparatus for light-emitting diode

(75) Inventor: Been Yu Liaw, Taipei County (TW)

Correspondence Address: Been Yu Liaw, P.O. Box 44-2049, Taipei, 10668, TW

(73) Assignee: Ecolighting, Inc.

(21) Appl. No.: 12/292,919

(22) Filed: Dec. 1, 2008

(51) Int. Cl. F21V 29/00

(52) U.S. Cl. 362/373

(57) ABSTRACT

The present invention disclosed a heat-dissipating module for a light-emitting diode (LED), comprising:a LED substrate having a plurality of extending feet; a heat-dissipating device having a center portion; wherein the plurality of extending feet are bent downwards by an angel to be placed into the center portion so that the extending feet are tightly combined with the heat-dissipating device. A heat-dissipating apparatus for a light-emitting diode (LED) includes a heat-dissipating device, a LED substrate, a ring, and an electrically controlled carrier assembly. The heat-dissipating device has a hollow center potion. The LED substrate having a plurality of extending feet is bent downwards at an angle of 90 degrees. The LED substrate is placed into the hollow center potion of the heat-dissipating device so that the extending feet can be tightly combined with the heat-dissipating device. The electrically controlled carrier assembly is disposed in a lower half portion of the center potion of the heat-dissipating device, for driving at least one LED.

### BACKGROUND OF THE INVENTION

(1) Field of the Invention

The invention relates to a heat-dissipating apparatus for a light-emitting diode (LED), and more particularly to a heat-dissipating apparatus having a LED substrate, which has extending feet and can replace a thermal conductive carrier, so that the material can be saved, the heat dissipating efficiency can be enhanced, and the thermal impedance can be reduced.

(2) Description of the Prior Art

FIG. 1 is an exploded view of a heat-dissipating apparatus for a light-emitting diode (LED) lamp. As shown in FIG. 1, a thermal conductive carrier 17 is placed into a center potion of a heat-dissipating device 10. The thermal conductive carrier 17 includes a platform 173, a plurality of holes 171, and an inner hollow portion 172. After the thermal conductive carrier 17 is placed into the heat-dissipating device 10, the center potion of the heat-dissipating device 10 is divided into two spaces. A LED substrate 18 is disposed on the thermal conductive carrier 17, and wires of the LED penetrate through the holes 171 of the thermal conductive carrier 17 and are electrically connected to an electrically controlled carrier 20. The electrically controlled carrier 20 is disposed in a lower half portion of the center potion of the heat-dissipating device 10, and is electrically connected to the power source (no shown), for driving the LED, through electro-conductive pins 201. A ring 19 is disposed on the LED substrate 18. The heat dissipating path will be described in the following. The thermal energy of the LED substrate 18 is transferred to the thermal conductive carrier 17 through the heat sink compound, and then the fin heat-dissipating device 10 dissipates the thermal energy into the air.

However, the thermal impedance is too high and the heat dissipating effect is poor because the thermal energy of the LED substrate is transferred to the thermal conductive carrier through the heat sink compound and then to the fin heat-dissipating device in the heat-dissipating device of the LED lamp.

Thus, it is obtained that the heat-dissipating device of the conventional LED lamp still has inconvenience and drawback to be improved in practice. Thus, the present inventor has paid attention to the research and development according to the experience and the technology in manufacturing the associated products for many years, and thus developed this reasonable heat dissipating device of this invention capable of improving the above-mentioned drawback.

### SUMMARY OF THE INVENTION

In order to enhance the heat dissipating efficiency and reduce the thermal impedance, the objects of the invention will be described in the following.

The main object of the invention is to provide a heat-dissipating apparatus for a LED lamp. Extending feet of a LED substrate are bent downwards and can be tightly combined with the fin heat-dissipating device so that the thermal energy of the LED can be directly transferred to the fin heat-dissipating device and then dissipated into the air without through the heat sink compound and the thermal conductive carrier. Thus, the heat dissipating efficiency can be enhanced and the thermal impedance can be reduced.

Another object of the invention is to provide a heat-dissipating apparatus for a LED lamp. The extending feet of the LED substrate are bend upwards so that the extending feet can be tightly combined with the fin heat-dissipating device, the thermal energy of the LED can be directly transferred to the fin heat-dissipating device, and then the thermal energy can be dissipated into the air. Thus, the heat dissipating efficiency can be enhanced, and the thermal impedance can be reduced.

Still another object of the invention is to dispose a lens onto the LED substrate with the lens being accommodated within the space formed by the upwardly bent extending feet of the LED substrate. Thus, the light efficiency can be enhanced and the space can be saved.

To achieve the above-identified objects the invention is to provide a heat-dissipating apparatus for a LED. The heat-dissipating apparatus mainly includes a heat-dissipating device, a LED substrate, a ring disposed on the LED substrate, and an electrically controlled carrier assembly. The heat-dissipating device has a hollow center potion. The LED substrate has a plurality of extending feet bent downwards at an angle. The LED substrate is placed into the hollow center potion of the heat-dissipating device so that the extending feet can be tightly combined with the heat-dissipating device. The ring is disposed on the LED substrate. The electrically controlled carrier assembly is disposed in a lower half portion of the center potion of the heat-dissipating device, for driving at least one LED.

The above-identified angle is 90 degrees. The plurality of extending feet of the LED substrate may be made of aluminum, copper, any suitable thermal conductive metal or any thermal conductive alloy.

Further aspects, objects, and desirable features of the invention will be better understood from the detailed description and drawings that follow in which various embodiments of the disclosed invention are illustrated by way of examples.

### BRIEF DESCRIPTION OF THE DRAWINGS

FIG. 1 is an exploded view showing a heat-dissipating apparatus for a light-emitting diode (LED) lamp.

FIG. 2 is a schematic illustration showing a heat-dissipating module for a light-emitting diode (LED) having extending feet according to the invention.

FIG. 3 shows the heat-dissipating module for a light-emitting diode (LED) according to an embodiment of the invention.

FIG. 4 shows the heat-dissipating module for a light-emitting diode (LED) according to another embodiment of the invention.

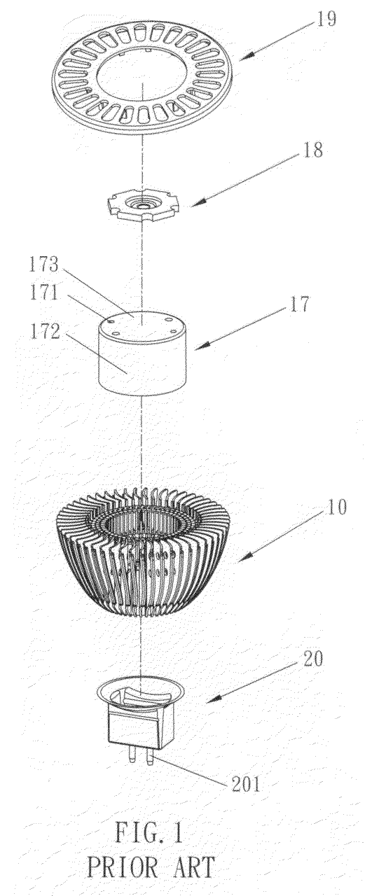

### DETAILED DESCRIPTION OF THE PREFERRED EMBODIMENTS

The characteristic contents, advantages and achieved effects of the present invention will become more fully understood from the detailed description given herein below and the accompanying drawings which are given by way of illustration only, and thus are not limitative of the present invention.

A heat-dissipating apparatus for a light-emitting diode (LED), comprising: a heat-dissipating device having a hollow center potion; a LED substrate having a plurality of extending feet, wherein the plurality of extending feet are bent downwards by an angel, the LED substrate is placed into the hollow center potion of the heat-dissipating device so that the extending feet are tightly combined with the heat-dissipating device; a ring disposed on the LED substrate; and an electrically controlled carrier assembly, disposed in a lower half portion of the center potion of the heat-dissipating device, for driving at least one LED.

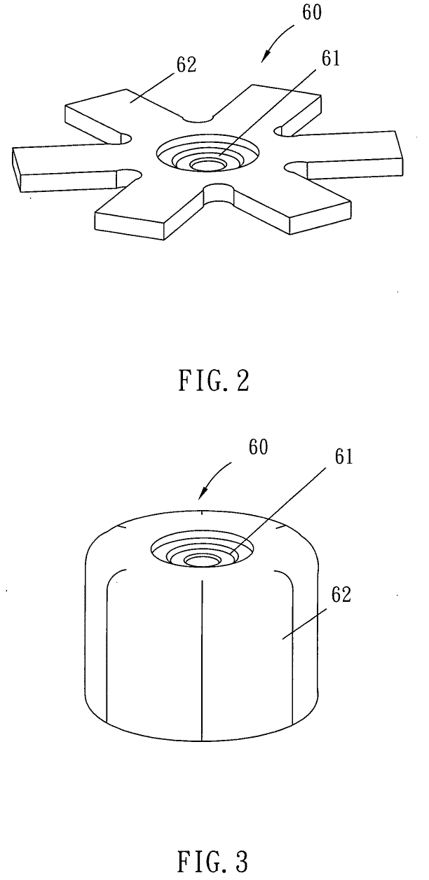

As shown in FIG. 2, the FIG. 2 is a schematic illustration showing a heat-dissipating module for a light-emitting diode (LED) having extending feet according to the invention. The LED is disposed on a LED substrate 61, which has a plurality of extending feet 62. The plurality of extending feet 62 may be bent downwards or upwards at an angle of 90 degrees so that the plurality of extending feet 62 may be tightly combined with of the fin heat-dissipating device. The plurality of extending feet 62 may be made of aluminum, copper, any suitable thermal conductive metal or any suitable thermal conductive alloy.

As shown in FIG. 3, the FIG. 3 shows the heat-dissipating module for a light-emitting diode (LED) according to an embodiment of the invention. The plurality of extending feet 62 of the LED substrate 60 are bent downwards at an angle of 90 degrees so that they can be tightly combined with the fin heat-dissipating device, and the thermal energy of the LED can be directly transferred to the fin heat-dissipating device through the plurality of extending feet 62 of the LED substrate, and then dissipated into the air.

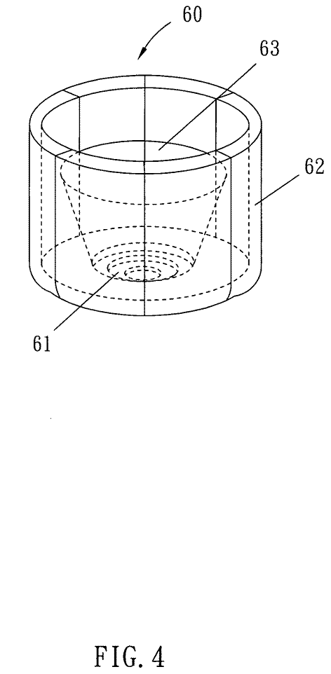

As shown in FIG. 4, FIG. 4 shows the heat-dissipating module for a light-emitting diode (LED) according to another embodiment of the invention. The plurality of extending feet 62 of the LED substrate 60 are bent upwards at an angle of 90 degrees so that they can be tightly combined with the fin heat-dissipating device, and the thermal energy of the LED can be directly transferred to the fin heat-dissipating device through The plurality of extending feet 62 of the LED substrate, and then dissipated into the air.

The plurality of extending feet 62 of the LED substrate 60 are bent upwards at an angle of 90 degrees to form a chamber for accommodating a lens 63 disposed on the LED to enhance the light efficiency and save the space.

In summary, the invention has overcome the drawbacks of the conventional structure and achieves the effects to be enhanced.

New characteristics and advantages of the invention covered by this document have been set forth in the foregoing description. It is to be expressly understood, however, that the drawings are for the purpose of illustration only and are not intended as a definition of the limits of the invention. Changes in methods, shapes, structures or devices may be made in details without exceeding the scope of the invention by those who are skilled in the art. The scope of the invention is, of course, defined in the language in which the appended claims are expressed.

What is claimed is:

1. A heat-dissipating apparatus for a light-emitting diode (LED), comprising:
a heat-dissipating device having a hollow center potion;
a LED substrate having a plurality of extending feet, wherein the plurality of extending feet are bent downwards by an angel, the LED substrate is placed into the hollow center potion of the heat-dissipating device so that the extending feet are tightly combined with the heat-dissipating device;
a ring disposed on the LED substrate; and
an electrically controlled carrier assembly, disposed in a lower half portion of the center potion of the heat-dissipating device, for driving at least one LED.

2. The apparatus according to claim 1, wherein the extending feet are made of aluminum, copper, any suitable thermal conductive metal or a thermal conductive alloy.

3. The apparatus according to claim 1, wherein the heat-dissipating apparatus is a heat dissipating fins.

4. The apparatus according to claim 1, wherein the angle is 90 degrees.

5. The apparatus according to claim 1, wherein the plurality of extending feet of the LED substrate are bent upward by 90 degrees.

6. The apparatus according to claim 5, further comprising a lens coupled to the LED substrate to enhance the light efficiency of the at least one LED.

7. The apparatus according to claim 1, wherein the angle is 90 degrees.

8. A heat-dissipating module for a light-emitting diode (LED), comprising:
a LED substrate having a plurality of extending feet;
a heat-dissipating device having a center portion;
wherein the plurality of extending feet is bent downwards by an angel to be placed into the center portion so that the extending feet are tightly combined with the heat-dissipating device.

9. The module according to claim 8, wherein the plurality extending feet are made of aluminum, copper, any suitable thermal conductive metal or a thermal conductive alloy.

10. The module according to claim 8, wherein the heat-dissipating apparatus is a heat dissipating fins.

11. The module according to claim 8, wherein the angle is 90 degrees.

12. The module according to claim 8, wherein the plurality of extending feet of the LED substrate are bent upwards at an angle.

13. The module according to claim 12, further comprising a lens coupled to the LED substrate.

14. The module according to claim 12, wherein the angle is wherein the angle is 90 degrees.
